(19) United States
(12) Patent Application Publication
(10) Pub. No.: US 2012/0000559 A1
(43) Pub. Date: Jan. 5, 2012

(54) DEVICE FOR MIXING AT LEAST TWO GASEOUS COMPONENTS

(75) Inventor: Jean-Luc Mussot, Loriol (FR)

(73) Assignee: AKHEA, Loriol (FR)

(21) Appl. No.: 13/142,637

(22) PCT Filed: Dec. 28, 2009
(86) PCT No.: PCT/FR2009/052706

§ 371 Date: Sep. 20, 2011

(30) Foreign Application Priority Data
Dec. 30, 2008 (FR) 0859108

(51) Int. Cl. F15D 1/00

(52) U.S. Cl. 137/861

(57) ABSTRACT

A device for mixing at least two gaseous components having at least two arms of a pneumatic circuit arranged in parallel and each being suitable for receiving one gaseous component, and for supplying a joint output line with the desired mixture. Each arm comprises a unit for adjusting the flow of the component in question and is made in a polyhedral block of a gastight material comprising at least two opposing flat surfaces to which the intake and output collectors of at least the portion of the pneumatic circuit that makes up said arm connect; said polyhedral blocks of each arm are brought together by assembling one flat surface of one block against a flat surface of the other block.

### BACKGROUND

This invention has for object a device for mixing at least two gaseous components in order to obtain a gaseous mixture containing a desired predetermined proportion of each of said gaseous components.

The technical sector of the invention is the realization of such mixing devices, also known as “gas mixers” of which there are many types for which is certain cases patent applications have been filed.

A first family includes the so-called static devices comprised of a chamber wherein a determined quantity of each gaseous component is injected and action is then taken in order to obtain a homogeneous mixture: this type of device does not make it possible, on the one hand to obtain the desired mixture immediately nor continuously and, on the other hand, requires the implementation of substantial means.

Another family of so-called dynamic devices consists in injecting flows servo-controlled by direct measurements of the content of each component in the mixture obtained. Flow meters and electronic mass flow controllers are often used for this, which has the disadvantage of making this type of mixer very expensive.

Finally, another family of devices, also dynamic, consists in mixing defined and continuous flows of each gaseous component delivered through an arm of a pneumatic circuit comprising successively a regulator in order to supply said component at a given fixed pressure, then a throttling port calibrated in order to obtain a determined flow, and resulting in a joint line with the other gaseous components: a perfecting of this type of device such as described in application FR 2 906 480 filed on 2 Oct. 2006, further comprises a means of stopping upstream from each calibrated port of the flow in such a way as to adjust the injected quantity of each component via a controlling of the opening and closing time of each means of stopping.

However, these diverse devices each have disadvantages such as the creation of circuits that are rather complex to implement with many connections and conduits to connect between the various pneumatic components, or the influence of components located upstream of the others and which as such disturb the operation of those positioned downstream.

### SUMMARY OF THE INVENTION

The objectives of this invention are to realize devices for mixing that are modular and compact, reducing the connections and limiting the influence of the upstream components on the downstream components in order to obtain at least one, and more, homogeneous mixture of given constant proportions of at least two gaseous components.

Such an objective is achieved by a device for mixing comprising at least two arms of a pneumatic circuit arranged in parallel and each being suitable for receiving a gaseous component at a given supply pressure, and for supplying a joint output line of the desired mixture; such a device is such that

each arm comprises a means for adjusting the flow of the component in question to a determined constant value that depends at least on the supply pressure of the component,

each arm is carried out in a polyhedral block made of a material that is tight to the diverse gaseous components and resistant to their supply pressure, comprising at least two opposing flat surfaces to which the intake and/or output collectors of at least the portion of the pneumatic circuit that makes up said arm connect,

said polyhedral blocks of each arm are brought together by assembling one flat surface of one block against a flat surface of the other block by causing the ports of joint output collectors of said arms to communicate.

These characteristics, although realized differently, are disclosed in GB A 1 130 692.

The device according to the invention further comprises at least one means of stopping of which the closing and opening can be controlled positioned downstream from the means for adjusting the flow of any gaseous component, said means of stopping (8) is a solenoid valve fixed directly on a surface adjacent to one of the flat surfaces (6) to which the intake and output collectors (7) of said block (11) connect, and connected to a secondary inlet (13e) and output (13s) of the portion of the arm (1) in question.

In a preferred embodiment each arm comprises downstream from its means for adjusting the flow a means of stopping of which the durations of closing and opening can be controlled according to at least the supply pressure of the means for adjusting the flow positioned upstream on the same said arm, with the opening and closing times of each means of stopping being variable, able to adjust the injected quantity of each component in the joint output line of the mixer and calculated according to the desired mixture in this line.

In a specific embodiment the internal portions of the circuit of each block are straight conduits pierced from the various surfaces of the block in question and of which the ports are able either to be sealed or able to constitute inlets or outputs of the internal portion of the circuit in question, and the means for adjusting the supply pressure as well as the means for adjusting the flow are incorporated into said block.

More preferably, each polyhedral block is a rectangular parallelepiped and comprises at least one supply inlet of a gaseous component and at least two outputs of the latter able to provide at least two different flows of this same gaseous component in two separate output lines and jointly with at least one other block supplied by a second gaseous component and making it possible as such to deliver at least two mixtures of a different constitution of gases.

The result is a new device for mixing gaseous components responding to the diverse disadvantages of the current devices and making it possible to respond to the objectives of this invention, while also bringing additional advantages that shall be noted and understood when reading the description hereinafter.

The latter and the attached drawings describe examples of embodiments of the invention but are in no way restrictive: other embodiments are possible within the framework of the scope and of the extent of this invention, in particular by changing the form of polyhedral blocks represented here in the form of a rectangular parallelepiped; these blocks could indeed be for example of triangular, hexagonal or octagonal section and not rectangular; in addition, mixers can be realized of more than two or three gaseous components by combining as many blocks as required.

### BRIEF DESCRIPTION OF THE DRAWINGS

FIG. 1 is a diagram of an embodiment with a single joint output means of stopping.

FIGS. 2 and 3 show two diagrams of two embodiments with a means of stopping the closing and the opening of which can be controlled positioned on each arm of a circuit.

FIG. 4 is a diagrammatical view of an example of a polyhedral block according to the invention.

FIG. 5 is a semi-exploded perspective view of an embodiment of such a block.

FIG. 6 is an external perspective view, of three blocks according to FIG. 5 and assembled against one another, realizing a device for mixing three gaseous components.

### DETAILED DESCRIPTION OF THE PREFERRED EMBODIMENT(S)

Such a device for mixing at least two gaseous components comprises at least two arms 1 of a pneumatic circuit arranged in parallel and each being suitable for receiving 3 a gaseous component at a given supply pressure P_{E} and for supplying a joint output line 2 of the desired mixture. According to the invention and what is shown in the attached figures:

each arm comprises a means for adjusting 4 the flow of the component in question to a determined constant value that depends at least on the supply pressure P_{A} of the component,

each arm 1 is realized in a polyhedral block 11 made of a material that is tight to the diverse gaseous components and resistant to their supply pressure, comprising at least two opposing flat surfaces 6 to which the intake and/or output collectors 7 of at least the portion of the pneumatic circuit that makes up said 1 connect.

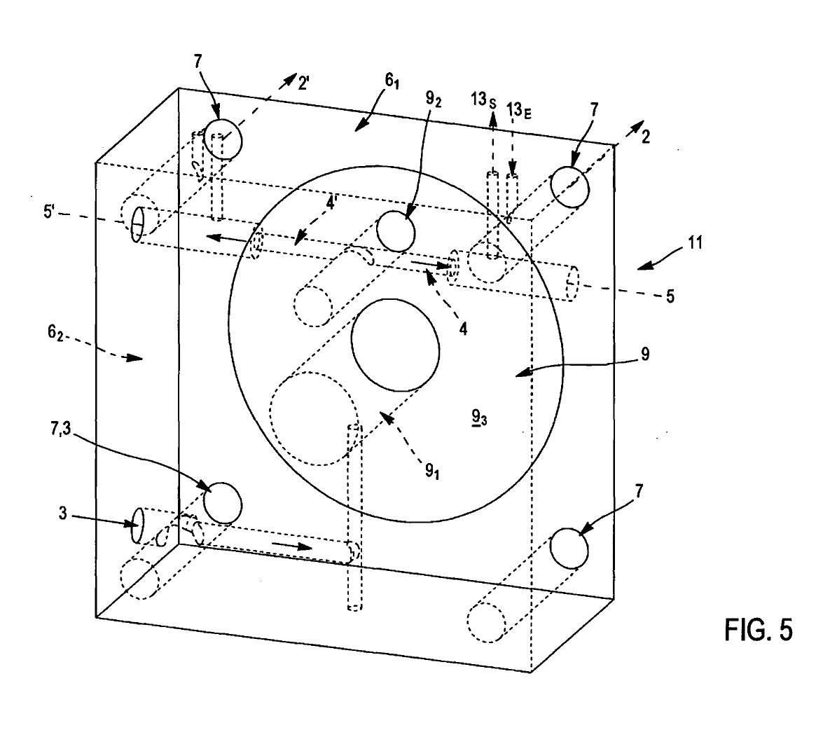

As shown in FIG. 5, all of the conduits and collectors of this pneumatic circuit are realized by piercing the block 11 from one of its surfaces: these piercings can cross between themselves and/or connect to a component incorporated into the block 11 (see hereinafter) when it is necessary to have them communicate. The ends of these piercings, connecting to one or two surfaces of the block 11, are either sealed according to the desired internal pneumatic circulation circuit, or are directly connected to an external component of the block in question or to another end of a piercing of another adjacent block (such as described in the following paragraph), or receive for at most two of them on the one hand the supply connection of the gaseous component and on the other hand according to the case that of the output of the mixture obtained.

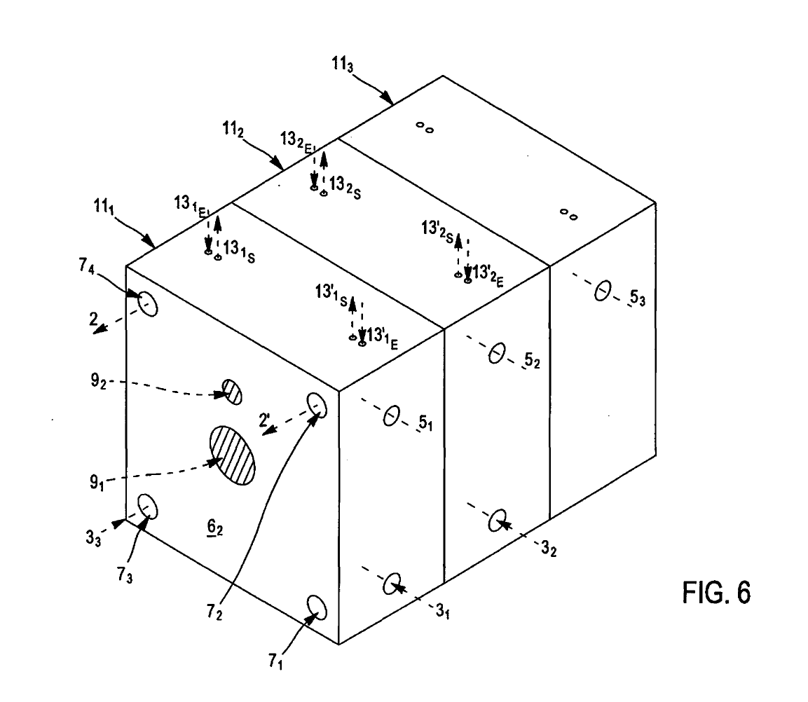

Said polyhedral blocks 11 of each arm 1 are brought together by assembling as shown in FIG. 6 one flat surface 6 of one block against a flat surface 6 of the other block by causing the ports of joint output collectors 7 of said arms to connect, and also according to the case the supply inlet of a gaseous component other than that of the block in question and which can as such supply a block that is different from the latter as shown by the inlet 7₃ of the block 11₁ which shall as such supply 3₃ the block 11₃ (although the block 11₁ can be supplied by either the lateral inlet 3₁ or by the other collector 7₁ of the surface 6₂ and which is sealed at its other end in relation to the block 11₂ which is then supplied by the inlet 3₂).

The device comprises at least one means of stopping 8 of which the closing and the opening can be controlled by any means 14 on the one hand for measuring and for comparing at least the pressure and on the other hand for controlling; the means of stopping is positioned downstream from the means for adjusting 4 the flow of any gaseous component.

Positioning the means of stopping 8 downstream from the means for adjusting 4 makes it possible to control the supply pressure P_{A} upstream of this adjusting member of the flow while when this means of stopping is positioned upstream from the latter, it introduces a loss of head that is difficult to assess and which can therefore modify the flow of this adjusting member.

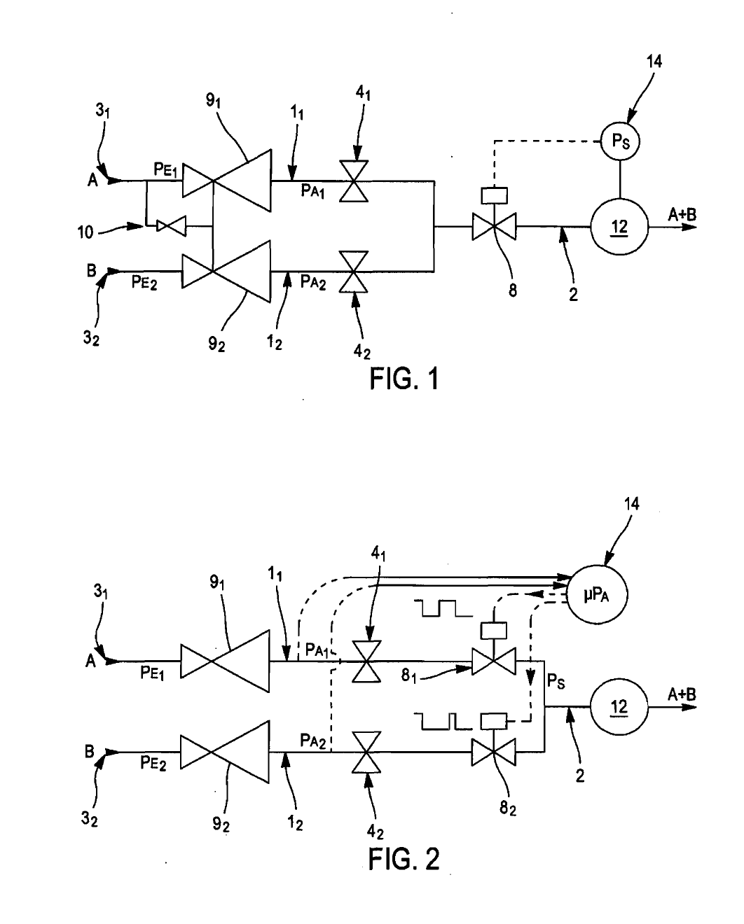

According to what is shown in FIG. 1, each arm 1 comprises upstream from the means for adjusting 4 the flow in this arm, a means of adjusting 9 the supply pressure P_{A} of the latter, and a means for controlling 10 this means of adjusting according to the inlet pressure P_{E} of the gaseous component in this means of adjusting the pressure; said means of adjusting 9 and of controlling 10 are able to provide a given supply pressure P_{A} of the means for adjusting the flow 4 located downstream: as such each gaseous component A or B, supplied by each arm 1₁, 1₂, connects in a joint output line 2 with, each one, a given flow, and it is then sufficient for a single joint means of stopping 8 on this output line, which can itself be controlled by a device 14 for measuring the pressure of a buffer volume 12 positioned downstream, and making it possible to supply the latter and to constantly maintain it at a given minimum pressure for the final use F.

In a preferred embodiment each means for adjusting 4 the flow, and the same applies in all of the other embodiments described hereinafter, is a restriction nozzle of the section of passage of the circuit of the arm 1 in question and is able to provide a sonic flow which is only according to its upstream supply pressure P_{A}: an example embodiment of such a pneumatic component is described in patent application FR 2 906 590 filed on 2 Oct. 2006, wherein the restriction nozzle 15 of the section of passage of the circuit can itself be adjusted in order to adapt the desired flow to the predetermined upstream pressure; this adjusting being carried out for each given condition of use and normally not modifiable during the course of use even if in certain cases this could be considered.

In order for the restriction nozzles of the section of passage of the circuit of the arm 1 in question to be able to provide sonic flows, in order to prevent an influence of the downstream pressure, the circuits of which they are a part must be configured in order to provide a critical and supercritical flow such that the ratio of the upstream pressure P_{A} to the downstream pressure P_{S} is less than 0.53 for diatomic gases, which can be controlled by taking a measurement of the output pressure P_{S}.

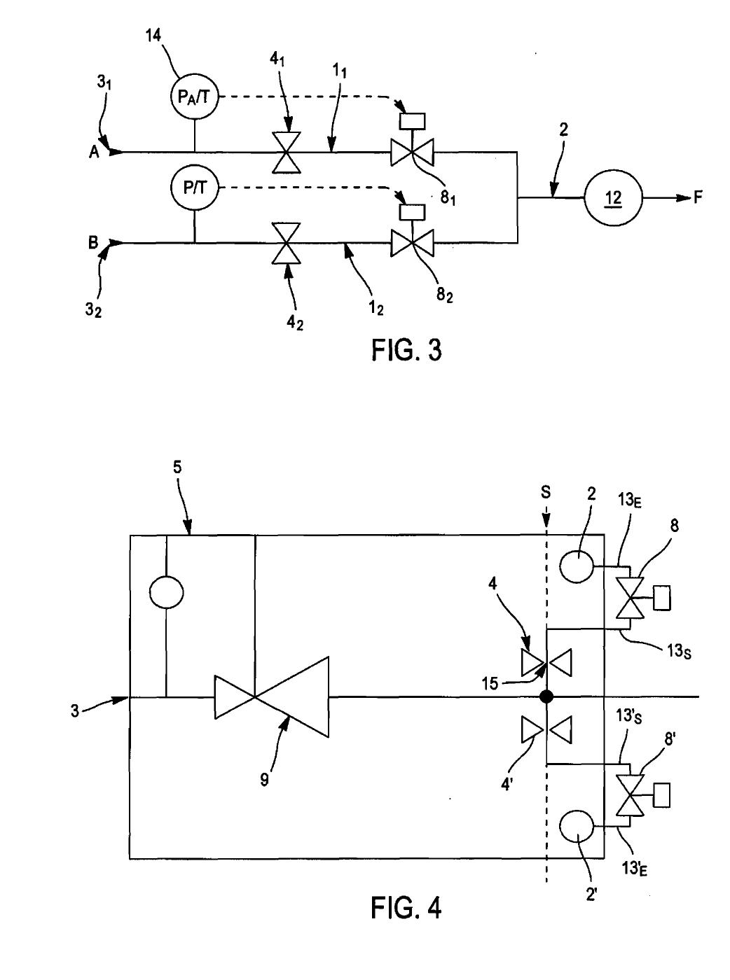

According to FIGS. 2 and 3, each arm 1 comprises downstream from its means for adjusting the flow 4 a means of stopping 8 that can be controlled, for the durations of closing and of opening, by an means 14 for measuring and for comparing at least the pressure P_{A} and of controlling such as by a microprocessor, according to at least the supply pressure P_{A} of the means for adjusting 4 the flow positioned upstream on the same said arm; the opening and closing times of each means of stopping are variable, and are able to adjust the injected quantity of each component in the joint output line 2 of the mixer and calculated according to the desired mixture in this line.

These means 14 for measuring and for controlling at least the upstream supply pressure P_{A} therefore make it possible to adjust the durations and the frequencies of opening and of closing of the means of stopping 8 and therefore to control the flows obtained that are desired to be constant for each gaseous component in order to continuously have a final gaseous mixture, in the joint output line 2, of stable composition, even if there are variations in pressure P_{A} upstream from the flow controllers 4. This makes it possible to avoid having a control of the means of adjusting 9 of the supply pressure P of each component, as shown in FIG. 2, or even to not have means of adjusting 9 the pressure P, as shown in FIG. 3.

In order of course to have a better precision for controlling these means of stopping 8, it is useful and even necessary to have a measurement not only of the pressure but also of the temperature of the gaseous component and to take this into account in the means of controlling 14.

More preferably, each means of adjusting 9 the supply pressure of the means for adjusting 4 the flow is a regulator, which can be incorporated on a surface of the blocks 11 such as shown in FIGS. 5 and 6 where are shown only diagrammatically the inlet 9₁ and outlet 9₂ portions of the regulator (which are of course sealed at the end connecting on the surface 6₂ of the block 11) of the regulator 9 with the housing 9₃ of its membrane 9₃.

In FIG. 6 the two regulators of the blocks 11₂ and 11₃ are arranged across from each other during the assembly of the two blocks of each arm of each component in question.

The means of stopping 8 of which the closing and the opening can be controlled are more preferably solenoid valves each fixed directly on a surface adjacent to one of the flat surfaces 6 to which the intake and output collectors 7 of the block 11 of the arm of the pneumatic circuit 1 of which they are a part connect, and connected to a secondary inlet 13_{E} and an output 13_{S} of this portion of the arm 1, such as shown in the diagram in FIG. 4 and, with regards to what is shown of the secondary inlets-outputs, in FIGS. 5 and 6.

The means for adjusting the flow 4 can be adjusted as indicated previously (for a given use in order to obtain a determined mixture) from an exterior pieced access 5 and located in the axis of their nozzle 15.

This invention therefore makes it possible to assemble as shown in FIG. 6, three blocks together which is facilitated by the modularity of the blocks, and to realize a three-channel mixer and, with independent joint outputs 2 and 2′ (thanks to communicating collectors 7₂ and 7₄), two ternary mixtures of different composition. Mixers of more than three gaseous components can also be realized by adding as many blocks as required.

In order to realize a complete mixer, to this assembly of blocks must then of course be added all of their external components such as the shut-off solenoid valves 8, pressure sensors directly on the available ports (and which are then sealed by these sensors) of the various collectors (such as those of the joint inlets and outputs 7), an electronic board in order to manage according to these measurements of pressure and those of temperature the solenoid valves for the flow adjustment of each component in order to obtain the desired gaseous mixtures.

1-9. (canceled)

10. Device for mixing at least two gaseous components comprising: at least two arms of a pneumatic circuit arranged in parallel and each said arm being suitable for receiving a gaseous component at a given supply pressure, and for supplying a joint output line of the desired mixture
each said arm comprising a means for adjusting the flow of a component in question to a determined constant value that depends at least on the supply pressure of the component,
each said arm being carried out in a polyhedral block made of a material that is tight to the diverse gaseous components and resistant to the supply pressure, comprising at least two opposing flat surfaces to which intake and output collectors of at least the portion of the pneumatic circuit that makes up each said arm connect,
said polyhedral blocks of each arm are brought together by assembling one flat surface of one block against a flat surface of the other block by causing ports of joint output collectors of said arms to communicate,
at least one means for stopping of which a closing and an opening can be controlled positioned downstream from the means for adjusting the flow of any gaseous component, said means for stopping being a solenoid valve fixed directly on a surface adjacent to one of the flat surfaces to which the intake and output collectors of said block connect, and connected to a secondary inlet and output of a portion of the arm in question.

11. Device for mixing according to claim 10, wherein each said arm comprises downstream from said means for adjusting the flow, said means for stopping of which the durations of closing and opening can be controlled according to at least the supply pressure of the means for adjusting the flow positioned upstream on the same said arm, with opening and closing times of each said means for stopping being variable, able to adjust the injected quantity of each component in the joint output line of the mixer and calculated according to a desired mixture in this line.

12. Device for mixing according to claim 10, wherein each said arm comprises upstream from said means for adjusting the flow, a means for adjusting the supply pressure of the flow adjusting means.

13. Device for mixing according to claim 10, wherein each said arm comprises upstream from the means for adjusting the flow in said arm, a means for adjusting the supply pressure of the flow adjusting means, and means for controlling said means for adjusting the flow according to the inlet pressure of the gaseous component in said means for adjusting the supply pressure, said means for adjusting and for controlling being able to provide a given supply pressure of the means for adjusting the flow.

14. Device for mixing according to claim 13, wherein each said means for adjusting the flow is a restriction nozzle of a section of passage of the circuit of the respective arm in question and which is able to provide a sonic flow which is only according to its upstream supply pressure.

15. Device for mixing according to claim 10, wherein the internal portions of the circuit of each said block are straight conduits pierced from various surfaces of the block in question and of which the ports are able either to be sealed or able to constitute inlets or outputs of the internal portion of the circuit in question.

16. Device for mixing according to claim 12, wherein the means for adjusting the supply pressure is incorporated into said block.

17. Device for mixing according to claim 10, wherein characterized each said polyhedral block comprises an inlet for the supply of a gaseous component and at least two outputs able to provide at least two different flows of this same gaseous component in two separate output lines, and jointly with at least one other block supplied by a second gaseous component and, making it possible to deliver at least two mixtures of a different constitution of gases.

18. Device for mixing according to claim 10, wherein in each said block is a rectangular parallelepiped.
